(19) United States
(12) Patent Application Publication
(10) Pub. No.: US 2018/0142428 A1
(43) Pub. Date: May 24, 2018

(54) RECYCLED ASPHALT PRODUCTION APPARATUS

(71) Applicant: GREEN ASPHALT CO. LLC, Long Island City, NY (US)

(72) Inventor: Nima Roohi Sefidmazgi, Long Island City, NY (US)

(21) Appl. No.: 15/358,730

(22) Filed: Nov. 22, 2016

(51) Int. Cl. E01C 19/10; B01F 9/02; B01F 15/02; B01F 15/06

(52) U.S. Cl. CPC E01C 19/1027; B01F 9/02; B01F 2215/0063; B01F 15/063; B01F 2015/062; B01F 15/0227

(57) ABSTRACT

An apparatus for producing hot mix asphalt from 100% recycled pavement aggregates includes a rotatable inclined drum having a central axis and having a first and second end. A heat source spaced from one of the ends introduces hot gas into the drum via one of the first and second ends. An aggregate supply introduces aggregate into the drum through one of the first and second ends. A RAP collar spaced from the ends and positioned around the drum is used to introduce sand through openings beneath the collar into the drum as the drum is rotated. The RAP collar has an annular heat and smoke shield fastened around the drum for minimizing escape of hot gas from the drum openings beneath the RAP collar. The drum has replaceable buckets within the openings for receiving, holding and distributing sand into the drum as the drum rotates about its axis.

### BACKGROUND OF THE DISCLOSURE

This disclosure relates generally to asphalt production and more particularly to an apparatus for asphalt production utilizing 100% recycled pavement materials.

Aggregates, sand and composite materials processed within current asphalt production apparatuses and systems are very corrosive and abrasive to the mixer/dryer drum portion of the apparatus, especially where recycled materials are utilized. Recycled material is more abrasive and corrosive due to the remnant chemical additives and abrasive constituents typically present with such materials. Consequently, substantial downtime is required to replace worn drum parts. In addition, substantial gaseous exhaust cleaning and particulate removal efforts are required.

Therefore there is a need for an apparatus that minimizes both the effects of particle abrasion on the interior components of the mixer/dryer drum and the impact of release of environmental pollutants to the atmosphere.

### SUMMARY OF THE DISCLOSURE

An asphalt production apparatus in accordance with the present disclosure meets these needs, for example, by introducing replaceable buckets into the recycled asphalt pavement (RAP) collar structure, and/or providing a heat and smoke shield around the RAP collar. One embodiment of an apparatus in accordance with the present disclosure includes a rotatable inclined drum having a central axis and having a first and second end. The apparatus has a heat source spaced from one of the ends for introducing hot gas into the drum via one of the first and second ends, an aggregate supply for introducing aggregate into the drum through one of the first and second ends, and a stationary RAP collar between and spaced from the ends and positioned around the drum for introducing RAP sand and/or virgin sand through the RAP collar into the drum as the drum is rotated to mix and heat the aggregate and sand to form hot mix asphalt.

The RAP collar is stationary and the drum rotates within the RAP collar. The drum has a plurality of radial openings within the RAP collar through which sand can enter the drum via the RAP collar and at least one replaceable bucket fastened to the drum extending within each of the plurality of openings for receiving, scooping, holding and distributing RAP sand into an interior mixing space within the drum as the drum rotates about its axis. The drum has an annular side wall within the RAP collar that defines the plurality of radial openings. The RAP collar has at least one access door to provide access to the replaceable “buckets” or scoops that receive the RAP sand and direct it into the interior space of the rotating drum. Each of the replaceable buckets is removably fastened to the annular side wall within the RAP collar.

Each bucket includes a fixed portion and a replaceable portion. The fixed portion includes a base portion and an inner portion for directing sand into the interior of the drum. The replaceable external portion is removably fastened to the base portion of the bucket. The replaceable external portion is a rectangular plate removably fastened to the base portion of the bucket. This base portion has a flange and the flange and the rectangular plate each have a plurality of matching holes for receiving fasteners to secure the replaceable external portion in position. Preferably, each has two or more parallel rows of matching holes such that the plate can be selectively positioned on the flange as the distal end of the plate wears due to the abrasive nature of RAP sand being scooped up and guided by the buckets into the mixing internal area within the drum.

The apparatus for producing hot mix asphalt in accordance with an exemplary embodiment may alternatively be viewed as having a rotatable inclined drum having a central axis and having a first and second end, a heat source spaced from one of the ends for introducing hot gas into the drum via one of the first and second ends, an aggregate supply for introducing aggregate into the drum through one of the first and second ends, and a RAP collar spaced from the ends and positioned around the drum for introducing sand through the RAP collar into the drum as the drum is rotated to mix and heat the aggregate and sand to form hot mix asphalt. The drum has plurality of radial openings through which sand can enter via the RAP collar and an annular heat and smoke shield fastened to the RAP collar around the drum for minimizing escape of hot gas from the drum openings beneath the RAP collar.

The portion of the drum within the RAP collar preferably also includes at least one replaceable bucket within each of the plurality of openings for receiving, holding and distributing sand into the drum as the drum rotates about its axis. The drum has an annular side wall within the RAP collar defining the plurality of radial openings and the RAP collar is stationary and the drum rotates within the RAP collar. The RAP collar has at least one access door to provide access to the replaceable buckets. A replaceable portion of each of the buckets is removably fastened to a base portion of the bucket that is in turn fastened to the annular side wall of the drum within the RAP collar.

An embodiment of the apparatus for producing 100% recycled hot mix asphalt in accordance with the present disclosure may be viewed as including a rotatable inclined drum having a central axis and having a first and second end, a heat source spaced from one of the ends for introducing hot gas into the drum via one of the first and second ends, a 100% recycled asphalt pavement aggregate supply for introducing recycled aggregate into the drum through one of the first and second ends, and a RAP collar spaced from the ends and positioned around the drum for introducing 100% recycled asphalt pavement sand through the RAP collar into the drum as the drum is rotated to mix and heat the aggregate and sand to form hot mix asphalt.

The drum has plurality of radial openings through an annular side wall of the drum beneath the RAP collar through which sand can enter via the RAP collar, and has an annular heat and smoke shield fastened to the RAP collar around the drum for minimizing escape of hot gas from the drum openings beneath the RAP collar. The drum preferably has at least one replaceable bucket within each of the plurality of openings for receiving, holding and distributing 100% recycled RAP sand into the drum as the drum is rotated about its axis.

These and other features of embodiments in accordance with the present disclosure will become more apparent upon a reading and understanding of the following detailed description of various embodiments when taken in conjunction with the drawings.

### DESCRIPTION OF THE DRAWINGS

FIG. 1 is a schematic plan view of a 100% recycled asphalt pavement production apparatus in accordance with the present disclosure.

FIG. 2 is a schematic side view of the apparatus shown in FIG. 1.

FIG. 3 is a partial sectional side view of the apparatus shown in FIG. 2.

FIG. 4 is a radial cross sectional view through the RAP collar taken along the line 4-4 in FIG. 2.

FIG. 5 is a radial cross sectional view through the drum taken along the line 5-5 in FIG. 2, looking at the RAP collar.

FIG. 6 is an enlarged view of the circled portion of the view shown in FIG. 4.

### DETAILED DESCRIPTION

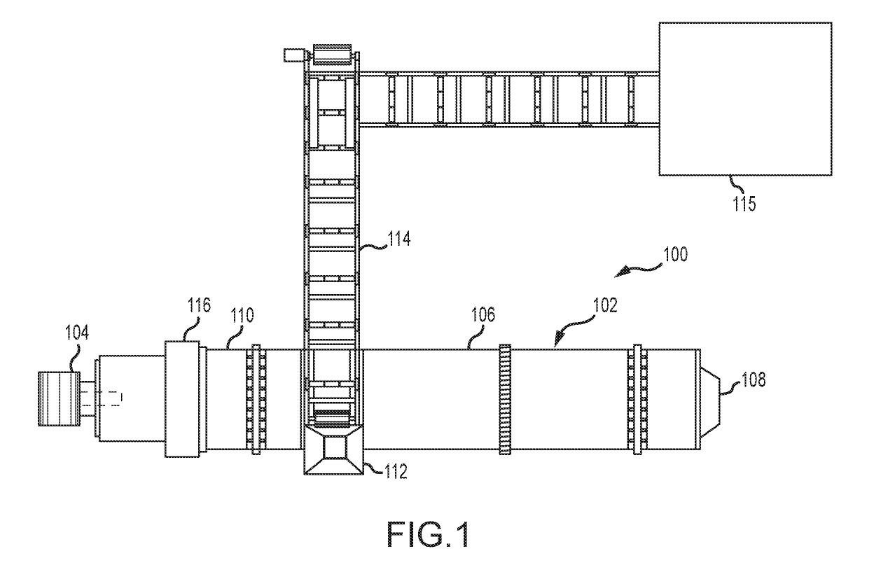

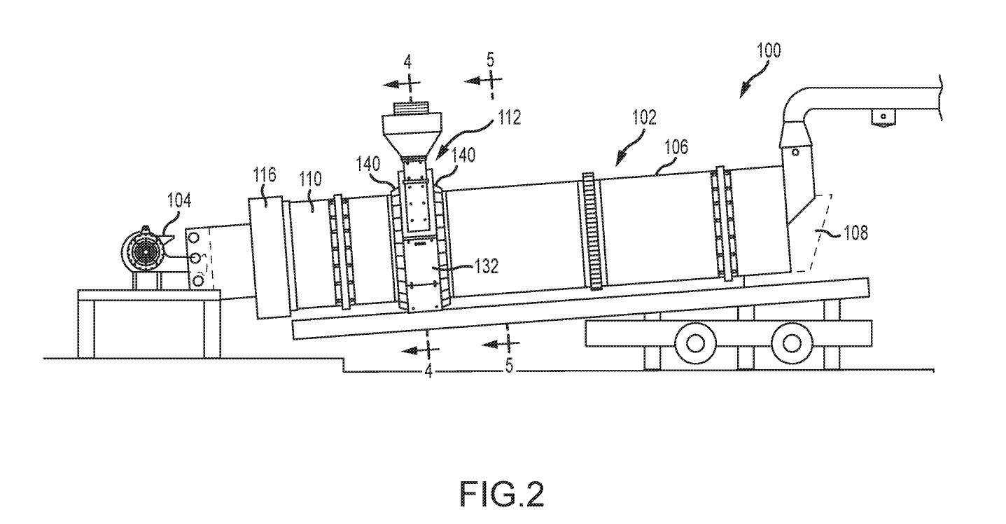

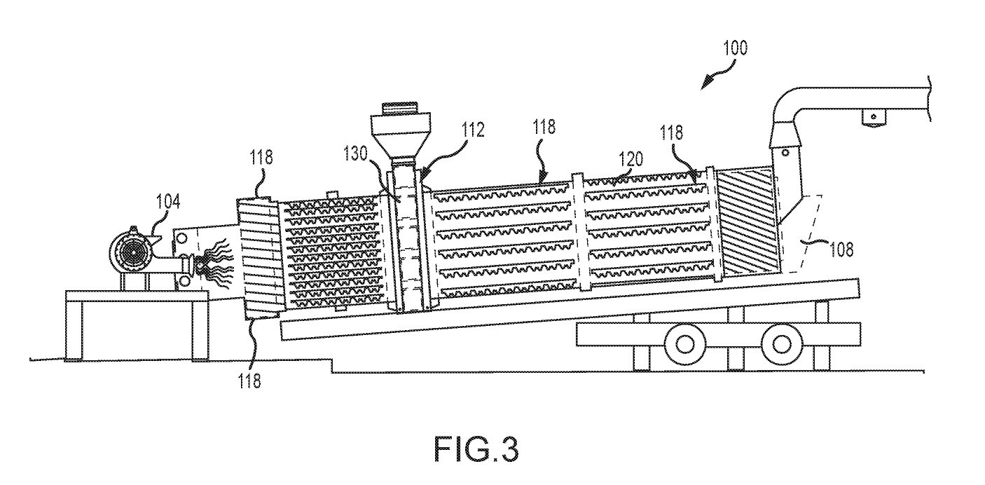

An exemplary asphalt production apparatus 100 in accordance with the present disclosure has a mixing/drying drum 106 that has internal aggregate mixing components including flights 118 (shown in FIG. 3) preferably made of Abrasalloy, an abrasion resistant alloy of steel made by Atlantic Steel Corporation having about 0.35% Carbon, 1% Cr, 0.75% Ma, 0.25% Mo, 0.35% Si and balance Fe. FIG. 1 is a schematic plan view and FIG. 2 is a side view of the hot-mix asphalt manufacturing system/apparatus 100 for use with 100% reclaimed asphalt pavement components in accordance with the present disclosure. It should be appreciated that other types of asphalt mixing systems may be utilized which incorporate features in accordance with the present disclosure.

This exemplary hot-mix asphalt manufacturing system 100 includes a rotary dryer 102 adapted to receive preferably recycled sand and crushed stone pavement ingredients of previously used hot-mix asphalt pavement and to perform a mixing and/or drying process on these ground up ingredients. Preferably, the rotary dryer 102 has a heat source, such as a burner 104, feeding heated air into a rotatable drum 106 axially mounted in tandem with the burner 104 so that the drum 106 rotates about an inclined axis with respect to a horizontal ground surface upon which the dryer 102 is supported. The rotatable drum 106 has a first end 108. Large grain recycled or virgin aggregate material is introduced into the dryer drum 106 at or near the first end 108 of the rotatable drum 106.

Fine grain aggregate, virgin sand or more preferably recycled asphalt pavement sand, is introduced through a stationary Recyclable Asphalt Pavement (RAP) collar 112, preferably located at about midway along the length of the rotatable drum 106, via a conveyor 114 from a sand bin 115. An outlet conveyor (not shown) similar to the conveyor 114 for the hot-mix asphalt manufactured by the rotary dryer 102 can be located at or near a discharge 116 adjacent the second or opposite end 110 of the dryer drum 106.

The rotary dryer 102 preferably may include mixing flights 118 (shown in FIG. 3) that are radially spaced apart, offset at an angle, and extending radially inward from the inner circumferential wall 120 of the rotatable drum 106. These flights 118 turn with the drum 106, mix and move the aggregate materials along the interior of the dryer drum 106, from the first end 108 and from the RAP collar 112, toward the second end 110 as the drum 106 is rotated. At the same time, hot air and combustion gases from the burner 104 flow in a counter flow fashion from the second end 110 of the rotary dryer 102 toward the first end 108 to heat and dry the ingredients as they are mixed and tumbled within the drum 106. It is to be understood that the arrangement may, in other embodiments, be reversed, with the flow of gas and hot air moving in the same direction as the flow of mixed ingredients. In such a case, the inclined nature of the dryer drum 106 would preferably be reversed such that gravity aids in the flow of the mixed ingredients.

Supplemental ingredients (conditioning oils or additives) can be introduced into the rotary dryer 102 at various appropriate locations along the length of the drum 106 so that these supplemental ingredients are mixed with the fine and course recycled or new aggregates at proper times during drying and in a uniform fashion. The supplemental ingredients can, for example, include asphalt cement, rejuvenators, plasticizers, and/or combinations thereof. Downstream (with respect to ingredient flow), the hot-mix asphalt manufactured by the rotary dryer 102 is allowed to drop through the outlet 116 onto a hot-mix conveyor (not shown) for delivery to an appropriate storage facility (also not shown).

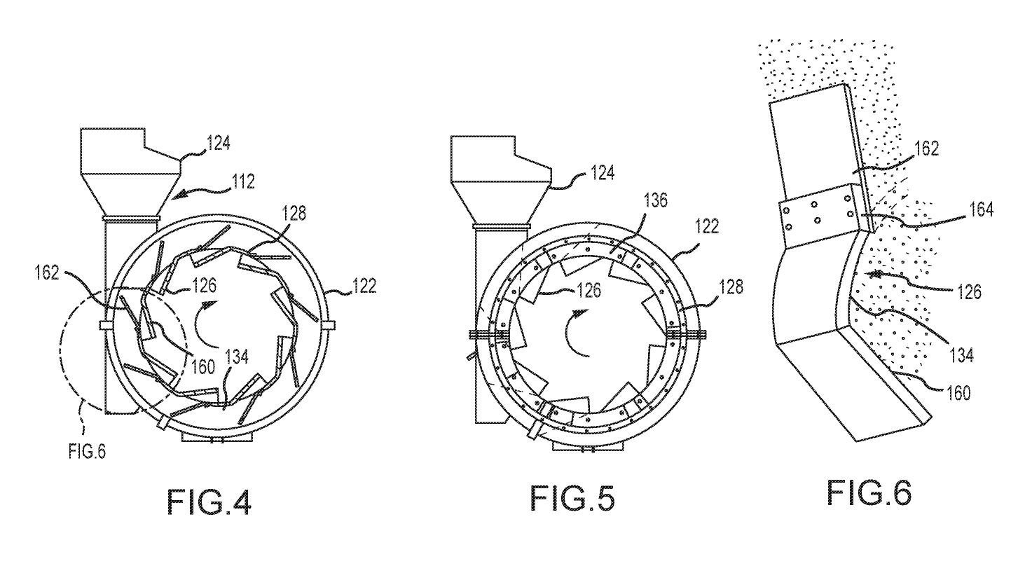

A radial cross sectional view through the RAP collar 112 of the dryer 102 taken along the line 4-4 in FIG. 2 is shown in FIG. 4. This RAP collar 112 is basically a stationary annular shell 122, wrapped around the drum 106, and has an upright inlet sand hopper 124 tangent to the annular shell 122 such that sand, either virgin sand or preferably recycled asphalt pavement or “RAP” sand, introduced through the top of the hopper 124 via conveyor 114, falls downward into the shell 122 and through rectangular openings 130 (shown in FIG. 3) in the peripheral annular side wall 128 of the portion of the drum 106 in the RAP collar 112 into buckets 126 that are fastened to the wall 128 of the rotating drum 106. As seen in FIG. 4, the drum 106 is rotated in a clockwise fashion. The peripheral side wall 128 of the drum 106 holding the buckets 126 rotates freely within the stationary shell 122. As the buckets 126 rotate with the drum 106 up and past a 12 o'clock position the bucket contents drop into the interior of the drum 106 and mix with the ingredients, primarily sand and larger aggregate material that entered through the inlet end 108 of the drum 106.

Each of the buckets 126 has an inner portion 160 and an external replaceable blade portion 162. Each bucket 126 is bolted to the peripheral annular side wall 128 of the drum 106 within the openings 130 and acts as a scoop to pick up and direct RAP sand from the hopper 124 through the openings 130 into and through the inner portions 160 of the buckets 126 into the ingredients mixing within the drum 106. Access to the replaceable external blade portions 162 of the buckets 126 is provided via access door 132 in the side of the annular shell 122, shown in the side view of the apparatus 100 in FIG. 2. Each of the buckets 126 has a base portion 134 that may be fastened to the periphery wall 128 via adjustable standoff straps 136 which can adjust the rake angle of the replaceable external blade portions 162 of the buckets 126 within the drum 106. Sand is generally introduced to the drum interior as the buckets 126 each rotate between the 7 o'clock and 11 o'clock position of each of the buckets 126. Each of the inner portions 160 of the buckets 126 is configured and positioned in the periphery wall 128 to drop most of the bucket content between the 12 o'clock and 3 o'clock position of the drum 106 as it is rotated.

An enlarged schematic perspective view of an exemplary bucket 126 is shown in FIG. 6. The external replaceable portion 162 is a generally flat rectangular blade preferably made of Abrasalloy that is removably bolted to a flange 164 extending from one of the base portions 134 of the peripheral annular wall 128 of the drum 106. These replaceable portions 162 may be flat, as shown, or may be curved to change the dynamics of the RAP sand scooping function within the hopper 124 during drum operation.

Returning now to the side view shown in FIG. 2, the portion of the drum 106 within the RAP collar 112 is covered, i.e., wrapped, with an annular heat and smoke shield 140 around each side of the RAP collar 112. This shield 140 is preferably made in arcuate sections from a heat resistant plastic material, or may be formed from arcuate sections of sheet metal. The shield 140 is fastened to the RAP collar shell 122 and does not rotate with the drum 106. The distal side edges of each segment of the shield 140 are positioned close to the surface of the drum 106 minimizing the gap between the shield 140 and the rotating drum 106 so as to minimize discharge of hot gases from within the drum to the environment.

There are many alternatives and modifications that will be apparent to those skilled in the art. For example, the external replaceable portions of the RAP sand buckets 126 may have a different shape than as shown. The inner portions 162 may also be replaceable. The shield 140 may be made of a high temperature polymer such as a nylon material. All such changes, alternatives and equivalents in accordance with the features and benefits described herein, are within the scope of the present disclosure. Such changes and alternatives may be introduced without departing from the spirit and broad scope of the invention as defined by the claims below and their equivalents.

What is claimed is:

1. An apparatus for producing hot mix asphalt comprising:
a rotatable inclined drum having a central axis and having a first and second end;
a heat source spaced from one of the ends for introducing hot gas into the drum via one of the first and second ends;
an aggregate supply for introducing aggregate into the drum through one of the first and second ends; and
a recycled asphalt pavement (RAP) collar between and spaced from the ends and positioned around the drum for introducing sand through the RAP collar into the drum as the drum is rotated to mix and heat the aggregate and sand to form hot mix asphalt, wherein the drum has plurality of radial openings within the RAP collar through which sand can enter via the RAP collar and at least one replaceable bucket within each of the plurality of openings for receiving, holding and distributing sand into the drum as the drum rotates about its axis.

2. The apparatus according to claim 1 wherein the drum has an annular side wall within the RAP collar defining the plurality of radial openings.

3. The apparatus according to claim 2 wherein the RAP collar is stationary and the drum rotates within the RAP collar.

4. The apparatus according to claim 1 wherein the RAP collar has at least one access door to provide access to the replaceable buckets.

5. The apparatus according to claim 2 wherein each of the replaceable buckets is removably fastened to the annular side wall of the drum within the RAP collar.

6. The apparatus according to claim 2 wherein each bucket comprises a fixed portion fastened to the drum and a replaceable external portion removably fastened to the fixed portion.

7. The apparatus according to claim 6 wherein the fixed portion of each bucket further comprises an inner portion for directing sand into the interior of the drum fixed to a base portion.

8. The apparatus according to claim 2 wherein the sand is recycled asphalt pavement sand.

9. The apparatus according to claim 6 wherein the replaceable external portion is a rectangular plate removably fastened to the base portion of the bucket.

10. The apparatus according to claim 9 wherein the base portion has a flange and the flange and the rectangular plate each have a plurality of matching holes for receiving fasteners.

11. An apparatus for producing hot mix 100% recycled asphalt comprising:
a rotatable inclined drum having a central axis and having a first and second end;
a heat source spaced from one of the first and second ends for introducing hot gas into the drum via the one of the first and second ends;
an aggregate supply for introducing aggregate into the drum through one of the first and second ends; and
a recycled asphalt pavement (RAP) collar spaced from the first and second ends and positioned around the drum for introducing sand through the RAP collar into the drum as the drum is rotated to mix and heat the aggregate and sand to form hot mix asphalt, wherein the drum has plurality of radial openings through an annular side wall of the drum through which RAP sand can enter via the RAP collar and wherein the RAP collar has an annular heat and smoke shield fastened to the RAP collar around the drum for minimizing escape of hot gas from the drum openings beneath the RAP collar.

12. The apparatus according to claim 11 further comprising at least one replaceable bucket within one or more of the plurality of openings for receiving, holding and distributing RAP sand into the drum as the drum is rotated about its axis.

13. The apparatus according to claim 11 wherein the drum has an annular side wall within the RAP collar defining the plurality of radial openings.

14. The apparatus according to claim 13 wherein the RAP collar is stationary and the drum rotates within the RAP collar.

15. The apparatus according to claim 12 wherein the RAP collar has at least one access door to provide access to the replaceable buckets.

16. The apparatus according to claim 12 wherein each of the replaceable buckets is removably fastened to the annular side wall of the drum within the RAP collar.

17. An apparatus for producing hot mix asphalt comprising:
a rotatable inclined drum having a central axis and having a first and second end;
a heat source spaced from one of the ends for introducing hot gas into the drum via one of the first and second ends;
a 100% recycled asphalt pavement aggregate supply for introducing aggregate into the drum through one of the first and second ends; and
a recycled asphalt pavement (RAP) collar spaced from the ends and positioned around the drum for introducing 100% recycled asphalt pavement sand through the RAP collar into the drum as the drum is rotated to mix and heat the aggregate and sand to form hot mix asphalt, wherein the drum includes an annular side wall within the RAP collar with a plurality of radial openings through which sand can enter via the RAP collar, an annular heat and smoke shield fastened to the RAP collar around the drum for minimizing escape of hot gases from the drum openings beneath the RAP collar, and wherein the drum has at least one replaceable bucket within each of the plurality of openings for receiving and distributing sand into the drum as the drum is rotated about its axis.

18. The apparatus according to claim 17 wherein the replaceable bucket has a base portion fixed to annular side wall of the drum, an inner portion, and a replaceable external portion removably fastened to the base portion.

19. The apparatus according to claim 18 wherein the base portion has a flange to which the replaceable external portion is fastened.

20. The apparatus according to claim 17 wherein the shield is formed by a plurality of arcuate metal plate sections each fastened to the RAP collar.
